(19) United States
(12) Patent Application Publication
(10) Pub. No.: US 2014/0150909 A1
(43) Pub. Date: Jun. 5, 2014

(54) Water Conveying System

(71) Applicants: Eli Zhadanov, Brooklyn, NY (US); Sam Zhadanov, Brooklyn, NY (US)

(72) Inventors: Eli Zhadanov, Brooklyn, NY (US); Sam Zhadanov, Brooklyn, NY (US)

(21) Appl. No.: 13/690,092

(22) Filed: Nov. 30, 2012

(51) Int. Cl. F17D 1/00

(52) U.S. Cl. CPC F17D 1/00
USPC 137/798

(57) ABSTRACT

A system for conveying water between water supplying elements has a first hollow water conveying member connectable to one water supplying element and a second hollow water conveying member connectable to another water supplying element and with the first water conveying members and turnable relative to one another about a turning axis, the first and second water conveying members have openings for water entry and water exit extending transversely to the turning axis and coaxial with each other, and a water conveying pipe is provided whose opposite ends can be connected with the water supplying elements via the water conveying members.

### BACKGROUND OF THE INVENTION

The present invention relates to systems for conveying water in particular between two water supplying elements, such as an upsteam water supplying element and a downstream water supplying element.

Systems of the above mentioned general type are known in the art. The known systems sometimes include a water conveying pipe having two ends provided at both ends with connecting means for connecting to a respective one of the water supplying elements. The connecting means have various designs and their use for connection of the water supplying elements with one another by the water conveying pipe can be substantially complicated. It is believed that the known systems can be further improved.

### SUMMARY OF THE INVENTION

Accordingly, it is an object of the present invention to provide a system for conveying water from a first water supplying element to a second water supplying element, which avoids the disadvantages of the prior art.

In keeping with these objects and with others which will become apparent hereinafter one feature of the present invention resides, briefly stated, in a system for conveying water from a first water supplying element to a second water supplying element, which includes a first hollow water conveying member connectable to the first water supplying element in water communication therewith; and a second hollow water conveying member connectable to the second water supplying element in water communication therewith and connected with said first water conveying member in water communication therewith, wherein said first and said second water conveying members, when they are assembled with one another, are turnable relative to one another about a turning axis between a plurality of angular positions relative to one another so that said the first water supplying element and the second water supplying element are locatable in a plurality of positions relative to one another; and wherein said first water conveying member has a first opening for water and said second water conveying member has a second opening for water, and said first opening and said second opening of said first and second water conveying members extends transversely to said turning axis and are coaxial with each other, so that the first and second water supplying elements connected by the device are coaxial with each other; and a water conveying pipe having two opposite ends formed so that said first water conveying member can be connected to one end of said water conveying pipe and said second water conveying member can be connected to another end of said water conveying pipe, or two first water conveying members can be connected to both ends of said water conveying pipe, or two second water conveying members can be connected to both ends of said water conveying pipe, to connect the ends of the water conveying pipe to the water supplying elements.

When the system for conveying water from a first water supplying elements to a second water supplying element is designed in accordance with the present invention, it provided various easily implementable possibilities for connecting of the water supplying elements with one another. On the one hand they can be connected with each other directly through the conveying device composed exclusively by the first and second water conveying members when they are assembled with each other and each connected to a corresponding one of the water supplying elements. On the other hand, the water supplying elements can be connected with each other through a combination of one water conveying member, the water conveying pipe connected to this water conveying member, and another water conveying member connected to the water conveying pipe.

In accordance with another feature of the present invention, said first and said second water conveying members are provided with first and second connecting means for connecting said first water conveying member to the first water supplying element and said second water conveying member to the second water supplying element.

In accordance with the invention, said connecting means can include a first connecting structure provide on one of said water conveying members and a second connecting structure provided in the other of said water conveying members and connectable with said first connecting structure.

In accordance with another feature of the invention said first connecting structure is an inner thread, and said second connecting structure is an outer thread, provided correspondingly on said first water conveying member and in said second water conveying member.

A further feature of the present invention resides in that in that one of said water conveying members has a portion with a concave surface, while the other of said water conveying member has a portion with a corresponding convex structure surface, so that when the water conveying member turnabout said pivot axis relative to one another said convex surface moves along said concave surface in correspondence therewith.

Still a further feature of the present invention is that said first water conveying member has a first channel extending from said first opening parallel to and offset from said first axis and a first hole extending from said first channel coaxially with said turning axis, while said second water conveying member has a second channel extending from said second opening parallel to and offset from said second axis and a second hole extending from said second channel coaxially with said turning axis and communicating with said first hole, so that water can flow successively from the first water supplying element through said first opening, said first channel, said first hole of said first water conveying member, and then through said second channel, said second hole and said second opening of said second water conveying member into the second water supplying element.

In accordance with still a further feature of the present invention, the device has means for immovable fixing said water conveying members relative to one another in any of their angular positions relative to on another, and said fixing means include a first fixing element which is partially insertable into said first hole of said first conveying member and a second fixing element which is partially insertable into said second hole of said second conveying member and interacting with said first fixing member to immovably connect said first and second water conveying members with another, and while one of said fastening elements can be treated bolt, the other of said fixing elements can be a threaded nut screwable on said threaded bolt.

In accordance with the inventions, sealing means can be provided for water-tight sealing of components of the device relative to one another and including a first tight sealing of components of the device relative to one another and including a first seal provided between said first fixing member and said first water conveying member, a second seal provided between said first fixing member and said first water conveying member, a second seal provided between said first and said second water conveying members, and a third seal provided between said second fixing member and said second fixing member.

Said first seal, said second seal and said third seal extends transversely to the turning axis, are coaxial with in the inventive device, can be arranged coaxially with each other and also coaxial with said turning axis.

In accordance with another feature of the present invention, a water conveying pipe is provided, whose ends can be connected with the water conveying members, and the water conveying members can be then connected with the water supplying elements, so that the water supplying elements are in a water communication with one another through the water conveying pipe and two water conveying members.

In accordance with another feature of the invention each end of the water conveying pipe is formed so that a fixing means can extend through each end of the water conveying pipe and one of the water conveying members and connect said water conveying member to this end of the water conveying pipe, with interposition of the sealing means.

The novel features of the present invention are set forth in particular in the appended claims. The invention itself however both as to its construction and it manner of operation will be understood from the following description of the preferred embodiments which is accompanied by the following drawings.

### BRIEF DESCRIPTION OF THE DRAWINGS

FIG. 1 is a cross section of a water conveying pipe of a water conveying system in accordance with the present invention;

FIGS. 2 and 3 are perspective views of two water conveying members of the inventive water conveying system;

FIGS. 4, 5 and 6 are a side view, a cross section and a plan view of a first water conveying member of the inventive water conveying system;

FIGS. 7, 8 and 9 are a side view, a cross section and a view from below of a second water conveying member of the inventive water conveying system;

FIGS. 10 and 11 are a cross section and a front view of the first and second water conveying members assembled with one another;

FIG. 12 is a perspective view of the water conveying pipe of the inventive water conveying system; and

FIGS. 13, 14 and 15 are perspective views of three different embodiments of the inventive water conveying system, with different arrangements of the water conveying members at the ends of the water conveying pipe.

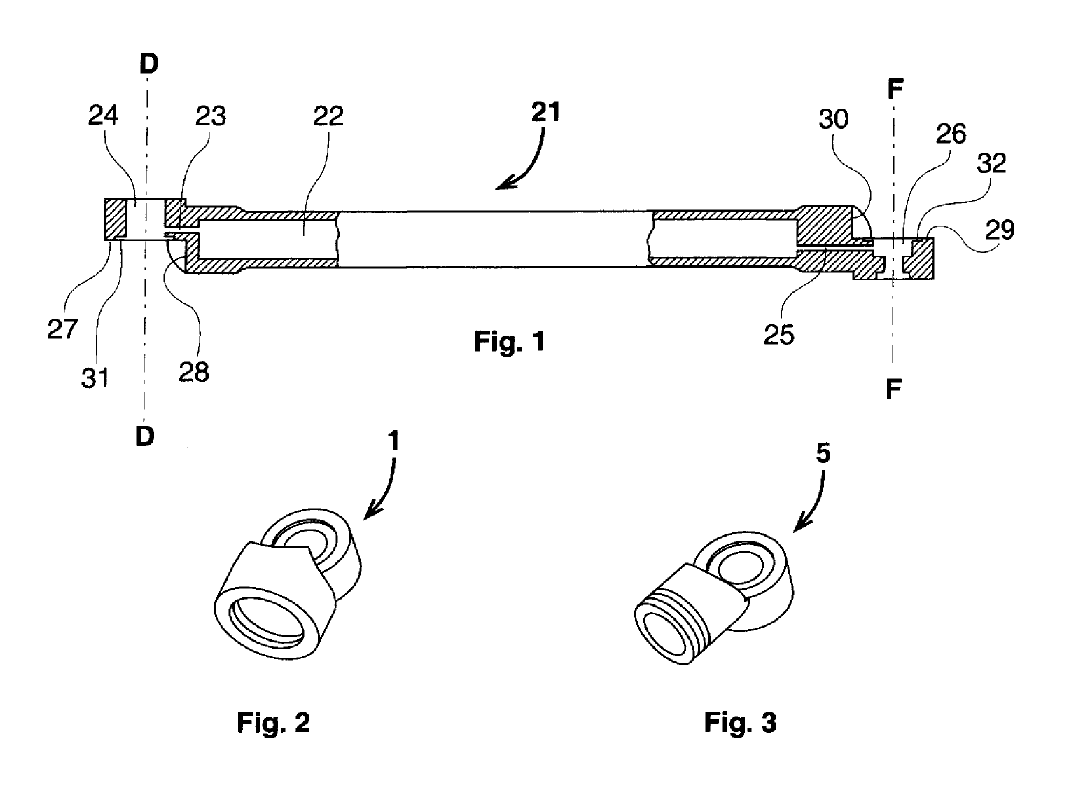

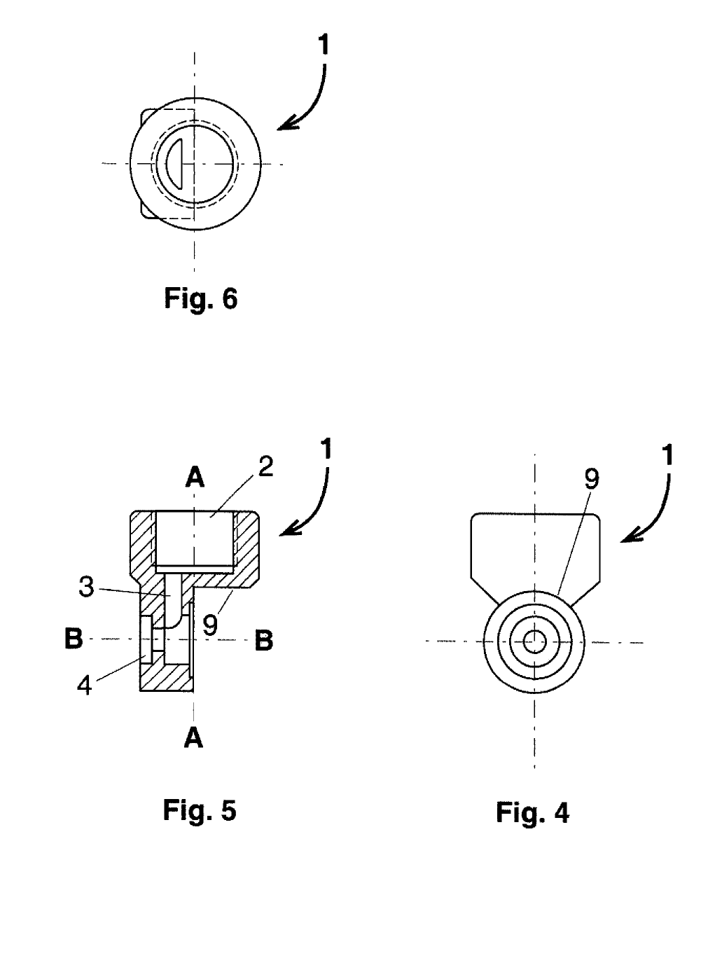

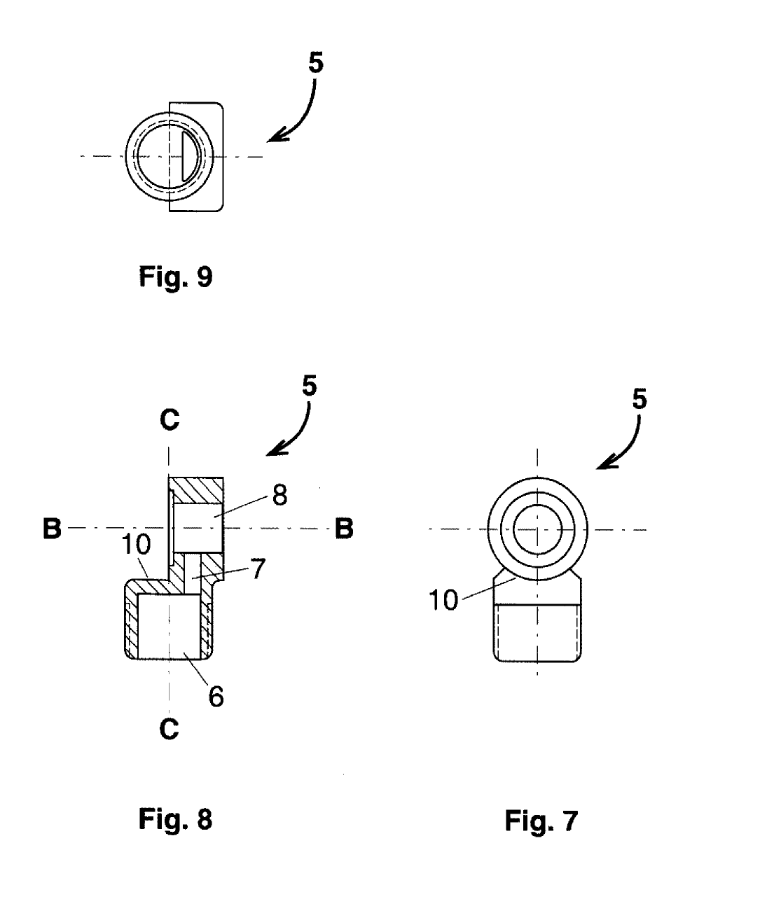

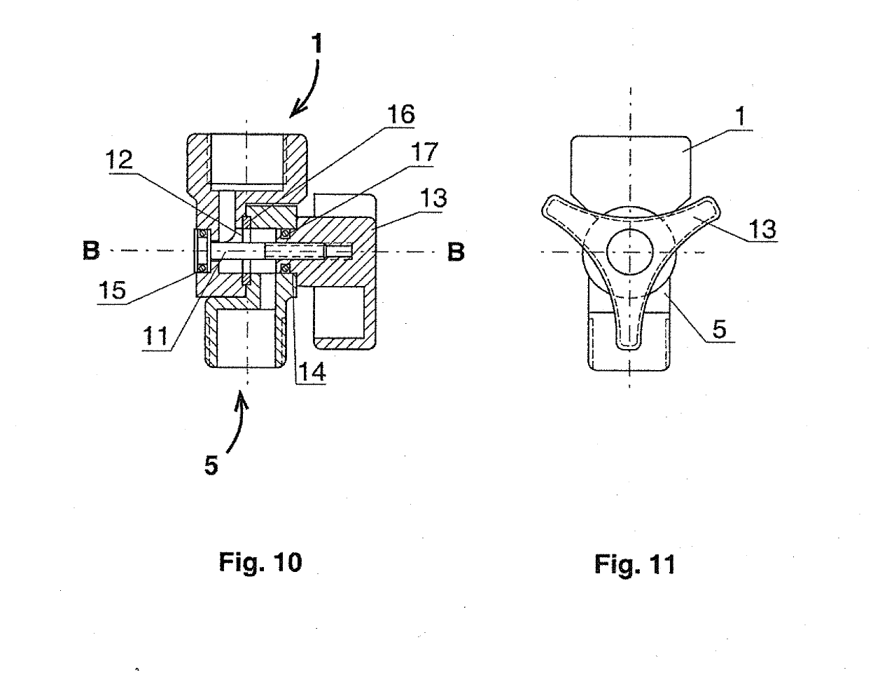

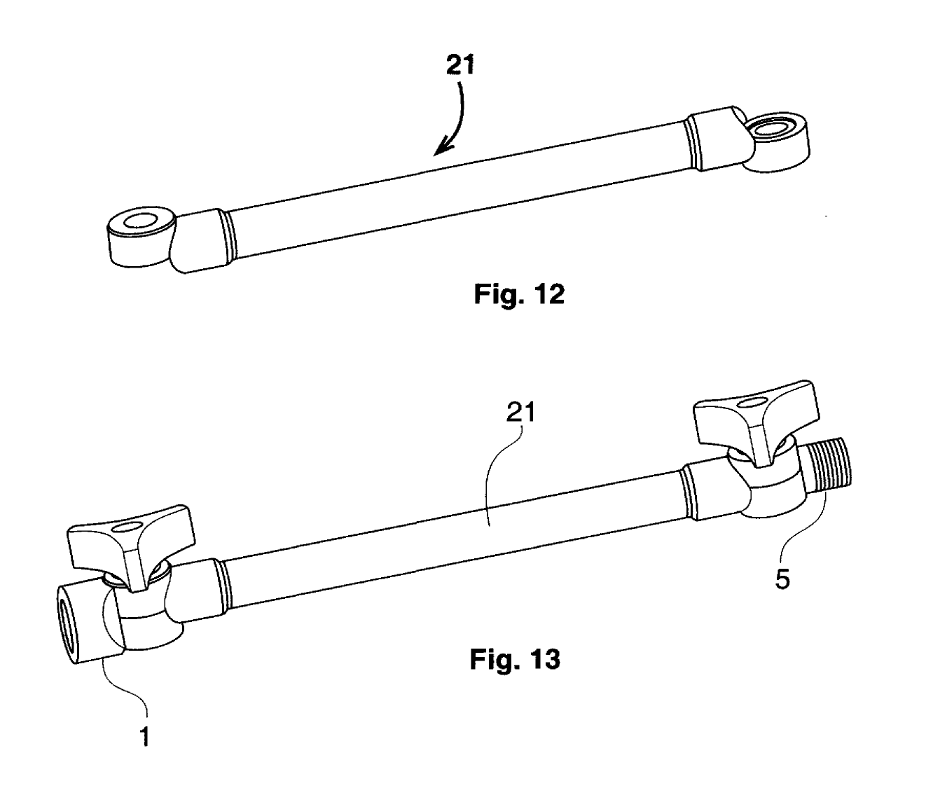

### DESCRIPTION OF THE PREFERRED EMBODIMENTS

A water conveying system in accordance with the present invention has two hollow water conveying members through which water can flow from a first water supplying element, for example a fixedly mounted water supplying pipe, to a second water supplying element, for example a showerhead, and which are turnable relative to one another about a turning axis, for example to change an orientation of the second water supplying member and also of water flow issues from the latter.

The first water conveying member is identified with reference numeral 1. It has a first opening 2 forming an inlet and having a first axis A-A, a channel 3 extending from the first opening 2 and having an axis parallel to the axis A-A, and a through hole 4 extending from the channel 3 along a turning axis B-B. The opening 2 is used for insertion of a first water supplying element and is provided with first connecting means formed as an inner thread engageable with an outer thread of the first water supplying element when an end part of the latter is inserted into the opening 2.

The second conveying member is identified with reference numeral 5. It has a second opening 6 forming an outlet and having a second axis C-C, a channel 7 extending from it and having an axis parallel to the axis C-C and a through hole 8 extending from the channel 7 along the turning axis B-B. A part of the second water conveying member, in which the second opening 6 is formed, is provided with connecting means formed as an outer thread engageable with an inner thread of the second water supplying element when an end part of the latter is pushed onto the above mentioned threaded part of the second water conveying member.

The first water conveying member 1 has a portion with a concave surface 9, while the second water conveying member has a portion with a convex surface 10 congruent with the concave surface 9, so that when the first and second water conveying member 1 and 5 are assembled with one another and turn relative to one another the surfaces 9 and 10 are slidable over one another, preferably with a sliding contact.

In order to assemble the first and second conveying members with each other, they are first brought into a contact with each other so that axes of their holes 4 and 8 coincide with one another and with the turning axis B-B, and then connecting elements connect them with each other. In this position the axes A-A and C-C of the first and second water conveying members 1 and 5 coincide with one another and form a continuation of each other. A first connecting element 11 is formed for example as a threaded bolt and inserted into the aligned holes 4 and 8 of the water conveying members so that its head is located in a part 12 of the hole 1, and the second connecting element 13 is formed for example as a nut and is introduced into a part 14 of the hole 8, to be screwed onto a threaded portion of the threaded bolt.

A first seal 15 is provided between the first connecting member or the threaded bolt 11 and the first water conveying member 1, a second seal 16 is provided between the water conveying members 1 and 5, and a third seal 17 is provided between the second connecting member or the nut 13 and the second water conveying members. The seals extend transversely to the turning axis B-B and are coaxial with it and with each other.

When for example the second water conveying water member 5 is now turned relative to the first water conveying member 1 to provide a desired angle between them and thereby a desired orientation of the outlet opening 6 relative to the inlet opening 2 and thus a desired orientation of the second water supplying element relative to the first water supplying element, and the nut 13 is tightened on the bolt 11 all seals axially compressed and immovably retained in their respective receiving openings with full water-tightness and the first and second water conveying element are immovably fixed with one another in a selected angular position.

The alignment of the axes A-A and C-C of the water conveying members provides for a novel construction of the device, which takes less space in the direction of the turning axis B-B and which prevents a side offset of the water supplying elements and provides their coaxially.

As described hereinabove the water conveying members can be assembled with one another and convey water directly through the thusly formed unit from one to the other water supplying element.

In accordance with the present invention, a water conveying pipe 21 is provided to realize a water flow from one of the water supplying element to the other water supplying element through the water conveying pipe whose ends are connected with the water supplying element via a corresponding one of the water conveying members.

FIG. 13 shows that one end of the water conveying pipe 21 is connectable with a not shown left water supplying element through the water conveying member 1, while its opposite end is connectable with a not shown right water supplying element through the water connecting member 5.

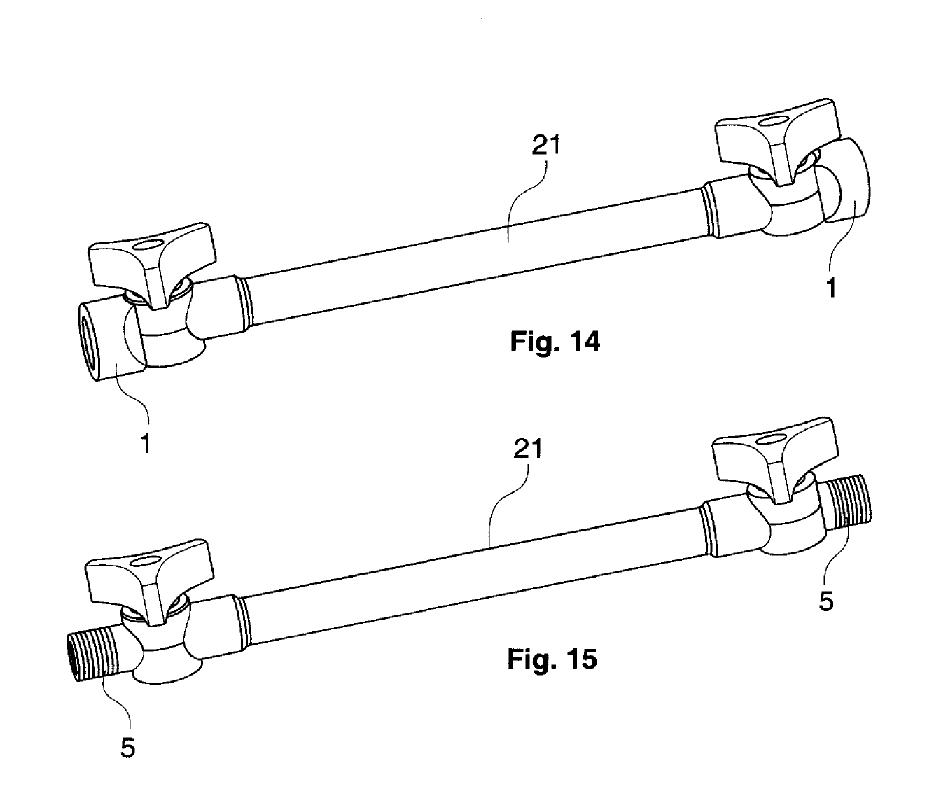

FIG. 14 shows that both ends of the water conveying pipe 21 can be connected with the not shown water supplying elements by two water conveying members 1, while FIG. 15 shows that both ends of the water conveying pipe 21 can be connected with the not shown water supplying elements via two water connecting members 5.

The water conveying pipe has a central throughgoing passage 22 extending in a direction of its longitudinal axis and communicating with an opening 23 and a channel 24 at one end and with an opening 25 and a channel 26 at another end, for a continuous water flow through all of them. The surfaces 27 and 28 at one end and 29 and 30 at the other end are configured to be compatible and form receptacles for corresponding parts of the water conveying members 1 and 5. The openings 24 and 26 are formed with axes D-D and E-E to coincide with the turning axis B-B of the water conveying members when they are assembled with the ends of the water conveying pipe 21.

When the water conveying members 1 and 5 are assembled with the water conveying pipe 21 as shown in any of the variants of FIGS. 13, 14, 15, the same fixing elements 11, 13 are used to tighten the connections, to hold the water conveying members in a desired angular position relative to the water conveying pipe, and to compress the seals between the thusly assembled components of the system. The seals can be introduced into depressions 31 and 32 at the corresponding ends of the water conveying pipe 21.

In this embodiment the water supplying elements are connectable with one another through the water conveying pipe and two water conveying members.

When all components of the system are connected with one another and with the water supplying elements, the central water passage of the water conveying pipe 21 is in a water flow communication with the water passages at the ends of the water conveying pipe, the water passages at the ends of the water conveying pipe are in a water flow communication with the water passages of the water conveying members, and the outlets/inlets of the water conveying members are in a water flow communication with the water conveying elements.

The invention is not limited to the details shown since various modifications and structural changes are possible without departing from the main spirit of the inventive system.

What is desired to be protected by letters patent is set forth in particular in the appended claims.

1. A system for conveying water from a first water supplying element to a second water supplying element, comprising a first hollow water conveying member connectable to the first water supplying element in water communication therewith; a second hollow water conveying member connectable to the second water supplying element in water communication therewith and connectable with said first water conveying member in water communication therewith so that said first and second water conveying members form a unit through which water flows directly from the first water supplying element to the second water supplying element, wherein said first and said second water conveying members, when they are connected with one another, are turnable relative to one another in direct surface-to-surface contact with one another over straight surfaces about a turning axis between a plurality of angular positions relative to one another so that said first water supplying element and the second water supplying element are locatable in a plurality of positions relative to one another; and wherein said first water conveying member has a first opening for water entry and said second water conveying member has a second opening for water exit, and said first opening and said second opening of said first and second water conveying members extend transversely to said turning axis and are coaxial with each other so that the water supplying elements connected by the device are also coaxial with each other; and a water conveying pipe positionable between said water conveying members and having two opposite ends connectable to said water conveying members in direct surface-to-surface contact over straight surfaces, to connect the ends of said water conveying pipe to the water supplying elements so that water flows from the first water supplying element through one of said water conveying members, then through said water conveying pipe, and then through another of said water conveying members to the second water supplying element.

2. A system for conveying water from a first water supplying element to a second water supplying element as defined in claim 1, wherein said first and said second water conveying members are provided with first and second connecting means for connecting said first water conveying member to the first water supplying element and said second water conveying member to the second water supplying element.

3. A system for conveying water from the first water supplying element and to a second water supplying element as defined in claim 2, wherein said connecting means include a first connecting structure provided on one of said water conveying members, and a second connecting structure provided in the other of said water conveying members.

4. A system for conveying water from a first water supplying element to a second water supplying element as defined in claim 3, wherein said first connecting structure is an inner thread, and said second connecting structure is an outer thread, provided correspondingly on said first water conveying member and in said second water conveying member.

5. A system for conveying water from a first water supplying element to a second water supplying element as defined in claim 1, wherein one of said water conveying members has a portion with a concave surface, while the other of said water conveying member has a portion with a corresponding convex surface, so that when said conveying members turn about said pivot axis said convex surface moves along said concave surface in correspondence therewith.

6. A system for conveying water from a first water supplying element to a second water supplying element as defined in claim 1, wherein said first water conveying member has a first channel extending from said first opening parallel to and offset from said first axis and a first hole extending from said first channel coaxially with said turning axis, while said second water conveying member has a second channel extending from said second opening parallel to and offset from said second axis and a second hole extending from said second channel and communicating with said first hole, so that water can flow successively from the first water supplying element through said first opening, said first channel, said first hole of said first water conveying member, and then through said second hole, said second channel and said second opening of said second water conveying member into the second water supplying element.

7. A system for conveying water from a first water supplying element to a second water supplying element as defined in claim 6, further comprising means for immovable fixing said water conveying members relative to one another in any of their angular positions relative to one another, said fixing means include a first fixing element which is partially insertable into said first hole of said first conveying member and a second fixing element which is partially insertable into said second hole of said second conveying member and interacting with said first fixing element to immovably connect said first and second water conveying members with one another.

8. A system for conveying water from a first water supplying element to a second water supplying element as defined in claim 7, wherein one of said fixing elements is a threaded bolt while the other of said fixing element is threaded nut screwable on said threaded bolt.

9. A system for conveying water from a first water supplying element to a second water supplying element as defined in claim 7, further comprising sealing means for water-tight sealing component of the system relative one another and including a first seal provided between said first fixing member and said first water conveying member, a second seal provided between said first and second water conveying members, and a third seal provided between said second fixing member and said second fixing member.

10. A system for conveying water from a first water supplying element to a second water supplying element as defined in claim 9, wherein said first seal, said second seal and said third seal extend transversely to said turning axis, are coaxial with each other and also coaxial with said turning axis and compressed when said fixing elements are connected with one another and tightened.

11. A system for conveying water from a first water conveying supplying element to a second water conveying supplying element as defined in claim 1, wherein each of the ends of said water conveying pipe are formed, so that a fixing means can extend through each end of said water conveying pipe and one of said water conveying members and connect said water conveying member to this end of the water conveying pipe with interposition of sealing means to fix an angular position of said water conveying members to said water conveying pipe and to compress the sealing means thus providing a water tightness.

12. A system for conveying water from a first water conveying element to a second water conveying element as defined in claim 1, further comprising sealing means including at least one sealing element components of the device.

13. A system for conveying water from a first water supplying element to a second water supplying element as defined in claim 1, wherein said opposite ends of said water conveying pipe are configured so that said first water conveying member can be connected to one end of said water conveying pipe and said second water conveying member can be connected to another end of said water conveying pipe, or two said first water conveying members can be connected to said ends of said water conveying pipe, or two said second water conveying members can be connected to said ends of said water conveying pipe in direct surface-to-surface contact over straight surfaces, to connect the ends of said water conveying pipe to the water to the water supplying elements.
